(19) United States
(12) Patent Application Publication
(10) Pub. No.: US 2019/0063383 A1
(43) Pub. Date: Feb. 28, 2019

(54) STRAINER AND FUEL PUMP MODULE HAVING THE SAME

(71) Applicant: COAVIS, Yeongi-gun (KR)

(72) Inventors: Jeong Sik KIM, Daejeon (KR); Woo Keun LEE, Daejeon (KR); Du Hyun KIM, Miryang-si (KR); Eun Ju LEE, Sejong-si (KR)

(21) Appl. No.: 16/171,829

(22) Filed: Oct. 26, 2018

Related U.S. Application Data
(62) Division of application No. 14/283,553, filed on May 21, 2014, now Pat. No. 10,145,341.

(30) Foreign Application Priority Data
May 23, 2013 (KR) 10-2013-0058095

(51) Int. Cl. F02M 37/14; F02M 37/22

(52) U.S. Cl. CPC F02M 37/14; F02M 2037/228; Y10T 137/794

(57) ABSTRACT

Provided is a strainer including: a filter paper filtering fuel and having a space part disposed therein; an inner rib disposed inside the filter paper; protruding parts protruding up and down from the inner rib to be disposed inside the filter paper; and a communicating pipe combined with the filter paper to communicate with the space part. The filter paper and the inner rib are partially folded up longitudinally. The folded portion is formed in a rounded form, and the upper and lower portions of the filter paper are formed not to contact each other at the folded portion. Widths of the protruding parts are each formed differently and distances between the protruding parts are each formed differently. The width and the distance are more narrowly formed at the portion at which the filter paper is folded than at the portion at which the filter paper is not folded.

### CROSS-REFERENCE TO RELATED APPLICATIONS

This application is a divisional application of U.S. Ser. No. 14/283,553, filed on May 21, 2014, which claims priority under 35 U.S.C. § 119 to Korean Patent Application No. 10-2013-0058095, filed on May 23, 2013, in the Korean Intellectual Property Office, the disclosure of which is incorporated herein by reference in its entirety.

### TECHNICAL FIELD

The present invention relates to a strainer and a fuel pump module having the same, and more particularly, to a strainer capable of preventing a filter paper from stopping since the filter paper contacts each other at a portion at which the strainer is folded, in the strainer connected to an inlet of a fuel pump or a fuel pump module to filter fuel sucked thereinto, and a fuel pump module having the same.

### BACKGROUND

An apparatus such as a vehicle which is driven by being supplied with liquid fuel such as a gasoline engine and a diesel engine is provided with a fuel tank and the fuel tank is provided with a fuel pump module, in which the fuel pump module is configured to be connected to the engine via a fuel supply line to supply fuel stored inside the fuel tank to the engine. In this case, a fuel inlet of the fuel pump module is provided with a strainer which primarily filters the fuel inside the fuel tank to be sucked into a fuel pump which is disposed inside the fuel pump module.

As illustrated in FIGS. 1 and 2, a strainer 4 is disposed at a fuel inlet 3a of a fuel pump 3 which is disposed inside a fuel tank 1 and in the strainer 4, to prevent a phenomenon that the filtering is not made since the filter paper 4b contacts each other at the time of the suction of fuel, a rib 4c which is provided with a plurality of protruding parts is inserted into or combined with the filter paper 4b.

However, the strainer is formed to be folded as occasion demands, and an upper filter paper and a lower filter paper contacts each other at the folded portion and thus the fuel may not be filtered or the filtered foreign materials are deposited at the folded portion of the filter paper and thus the filter paper may stop. Further, to design the strainer so that the strainer is folded at a desired portion, the rib needs to be added with the plurality of protrusions and thus the design of the strainer may be complicated.

As the related art, there is Korean Utility Model Laid-Open Publication No. 20-1989-010861 entitled “in tank type fuel pump”.

### RELATED ART DOCUMENT

### Patent Document

(Patent Document 1) KR 20-1989-010861 U (Jul. 11, 1989)

### SUMMARY

An exemplary embodiment of the present invention is directed to providing a strainer capable of preventing an upper filter paper and a lower filter paper from contacting each other at a folded portion of the strainer to prevent a deposition of filtered materials and a stoppage of the filter paper at the folded portion and a fuel pump module having the same.

In one general aspect, there is provided a strainer including: a filter paper 100 filtering fuel and having a space 130 disposed therein; an upper rib 210 combined with an outer upper portion of the filter paper 100; a plurality of protruding parts 300 protruding down from the upper rib 210 to be disposed inside the filter paper 100; and a communicating pipe 400 combined with the filter paper 100 to communicate with the space 130 of the filter paper 100, wherein the filter paper 100 and the upper rib 210 are partially folded up longitudinally, and the upper and lower portions of the filter paper 100 are formed not to contact each other at the folded portion.

The strainer may further include: a lower rib 220 combined with the outer lower portion of the filter paper 100; and the plurality of protruding parts 300 protruding up from the lower rib 220 to be disposed inside the filter paper 100; wherein the filter paper 100, the upper rib 210, and the lower rib 220 are partially folded longitudinally and thus the upper and lower portions of the filter paper 100 are formed not to contact each other at the folded portion.

The upper rib 210 and the lower rib 220 may be disposed in parallel to be spaced apart from each other in the width direction of the filter paper 100 and the upper rib 210 and the lower rib 220 may be alternately disposed.

Widths W of the protruding parts may be each formed differently and distances D between the protruding parts may be each formed differently, and the width W of the protruding part and the distance D between the protruding parts may be more narrowly formed at the portion at which the filter paper is folded than at the portion at which the filter paper is not folded.

In another general aspect, there is provided a strainer 1000 including: a filter paper 100 filtering fuel and having a space 130 disposed therein; an inner rib 230 disposed inside the filter paper 100; a plurality of protruding parts 300 protruding up and down from the inner rib 230 to be disposed inside the filter paper 100; and a communicating pipe 400 combined with the filter paper 100 to communicate with the space 130 of the filter paper 100, wherein the filter paper 100 and the inner rib 230 are partially folded up longitudinally, and the upper and lower portions of the filter paper 100 are formed not to contact each other at the folded portion.

Widths W of the protruding parts may be each formed differently and distances D between the protruding parts may be each formed differently, and the width W of the protruding part and the distance D between the protruding parts may be more narrowly formed at the portion at which the filter paper is folded than at the portion at which the filter paper is not folded.

In still another general aspect, there is provided a fuel pump module 2000 including: the strainer 1000 as described above, wherein the strainer 1000 is disposed inside a reservoir body 1200 in a partially folded state and a communicating pipe 400 of the strainer 1000 is connected to an inlet 1110 of the fuel pump 1100 which is disposed inside the reservoir body 1200.

### BRIEF DESCRIPTION OF THE DRAWINGS

FIGS. 1 and 2 are cross-sectional views illustrating a strainer and a fuel pump module according to the related art.

FIG. 3 is a cross-sectional view illustrating a strainer according to a first exemplary embodiment of the present invention.

FIGS. 4 and 5 are a cross-sectional view and a perspective view illustrating a state in which the strainer of FIG. 3 is folded.

FIG. 6 is a cross-sectional view illustrating a strainer according to a second exemplary embodiment of the present invention.

FIGS. 7 and 8 are a cross-sectional view and a perspective view illustrating a state in which the strainer of FIG. 6 is folded.

FIG. 9 is a cross-sectional view illustrating a strainer according to a third exemplary embodiment of the present invention.

FIG. 10 is a cross-sectional view and a perspective view illustrating a state in which the strainer of FIG. 9 is folded.

FIG. 11 is a perspective view illustrating an example in which the strainer according to the third exemplary embodiment of the present invention is modified.

FIG. 12 is a schematic cross-sectional view illustrating a fuel pump module having the strainer according to the exemplary embodiment of the present invention.

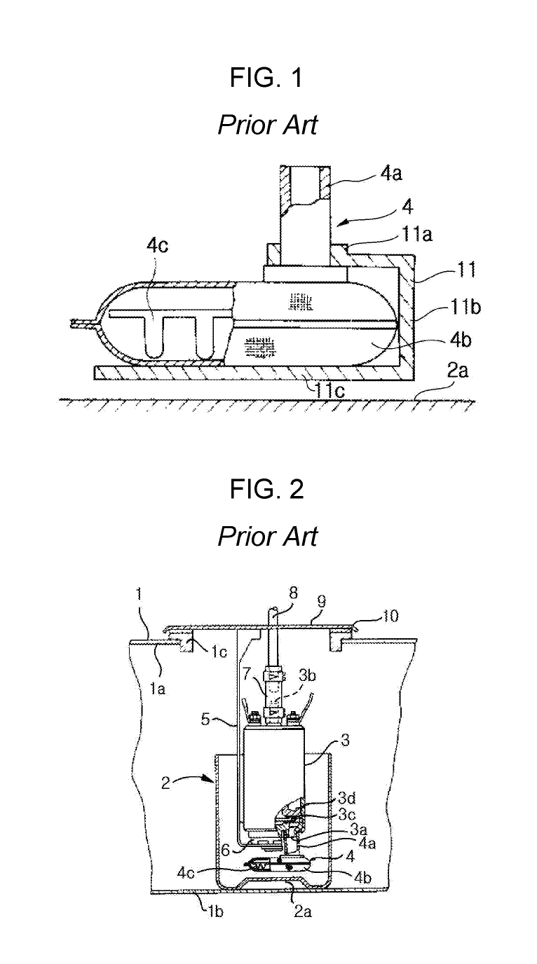

### DETAILED DESCRIPTION OF EMBODIMENTS

Hereinafter, a strainer and a fuel pump module having the same according to exemplary embodiments of the present invention will be described in detail with reference to the accompanying drawings.

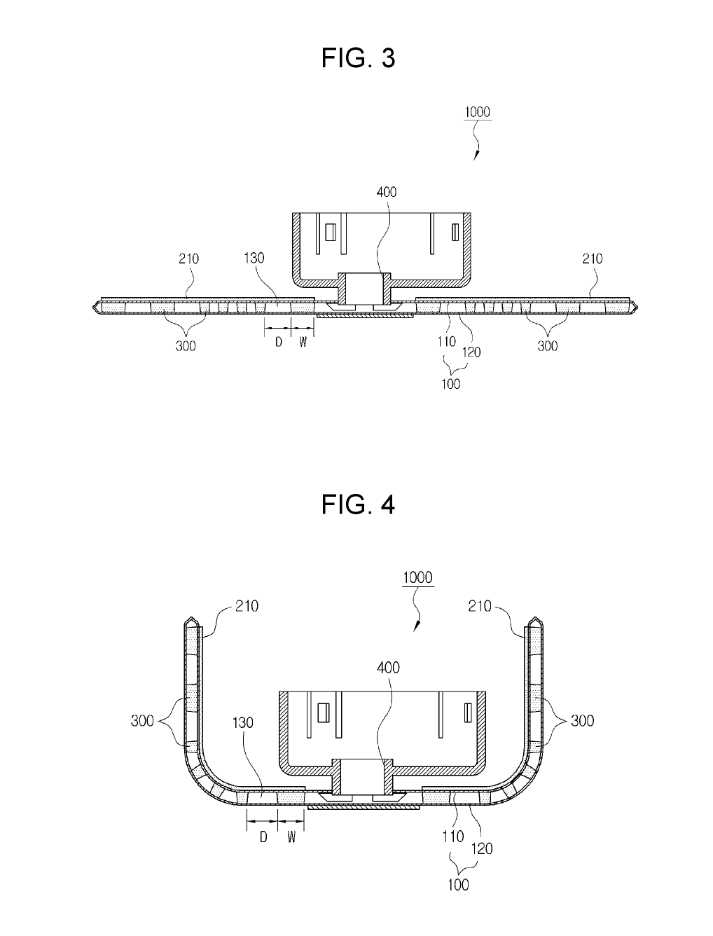

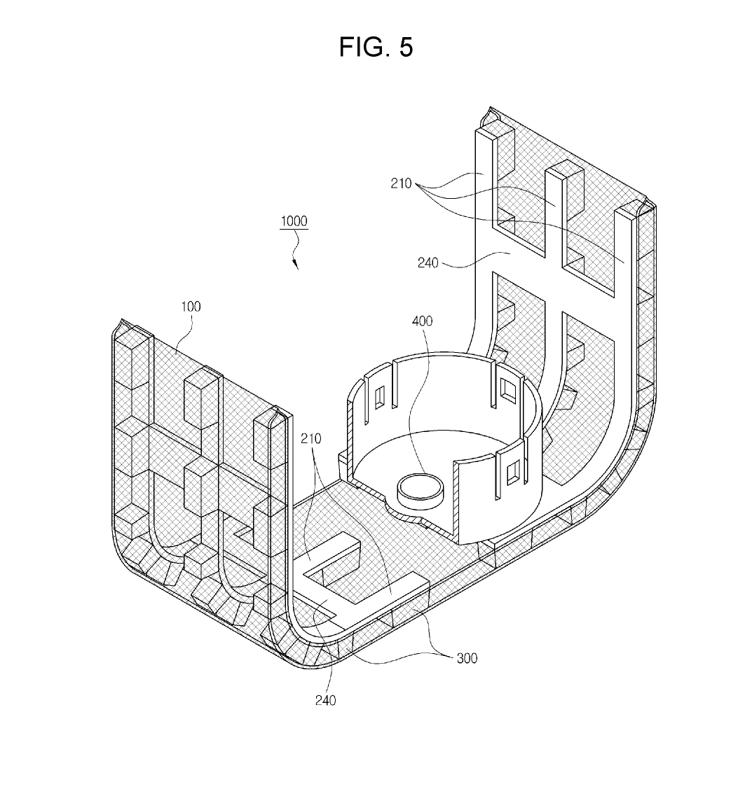

First, as illustrated in FIGS. 3 to 5, a strainer 1000 according to a first exemplary embodiment of the present invention includes a filter paper 100 filtering fuel. The filter paper 100 is formed of an upper filter paper 110 and a lower filter paper 120 and having a space 130 defined between the upper and lower filter paper 120. An upper rib 210 is disposed on the upper surface portion of the upper filter paper. A plurality of protruding parts 300 protrudes down from the upper rib 210 to be disposed inside the space 130 so as to maintain the space 130. A communicating pipe 400 is installed in the upper filter paper 110 to communicate with the space 130 of the filter paper 100. As shown in FIG. 5, the filter paper 100 and the upper rib 210 are partially folded. However, an upper filter paper 110 and the lower filter paper 120 are not contacted with each other by means of the protruding part 300 of the upper rib 210, even at the folded portion of the strainer 1000.

The filter paper 100 filters fuel and may be formed in a thin mesh form. Further, as described above, the filter paper 100 is formed of the upper filter paper 110 and the lower filter paper 120 spaced apart from each other so as to have the space 130 in-between. Edges of the upper filter paper 110 and the lower filter paper 120 are coupled with each other along the edges by a welding method, and the like.

The upper rib 210 is installed in an upper surface of the upper filter paper 110, which is the outer upper portion of the filter paper 100. In this configuration, the upper rib 210 is formed in a long bar shape and thus may adhere to the upper surface of the upper filter paper 110. Meanwhile, the upper rib 210 is formed in plural, in which the plurality of upper ribs 210 may be formed in parallel to be spaced apart from each other in a width direction of the strainer 1000. Further, when the upper rib 210 is formed in plural, a connection rib 240 which connects between the neighboring upper ribs 210 may also be formed. Therefore, as illustrated in FIGS. 3 to 5, the upper rib 210 supports the outer upper portion of the filter paper 100 and thus serves to maintain the form of the filter paper 100.

The protruding part 300 protrudes down from the upper rib 210 and is disposed inside the space 130. In this case, the protruding part 300 is formed in plural, in which the plurality of protruding parts 300 are formed along the upper rib 210, being spaced apart from each other. Further, a lower end of the protruding part 300 is extended to the upper surface of the lower filter paper 120 to maintain a distance between the upper filter paper 110 and the lower filter paper 120, i.e., maintain the space 130.

In this case, the upper filter paper 110, the upper rib 210, and the protruding part 300 are made of a plastic resin material. The upper rib 210 and the protruding part 300 are injection molded together, having the upper filter paper 110 disposed therebetween, such that the upper rib 210, the protruding parts 300 and the upper filter paper 110 are formed in an integral form where the upper rib 210 and the protruding part 300 down from the upper rib 210 penetrate through the upper filter paper 110. Therefore, the upper filter paper 110, the upper rib 210, and the protruding part 300 are integrally formed and then the edges of the upper filter paper 110 and the lower filter paper 120 are bonded to each other.

The communicating pipe 400 is disposed in the filter paper 100 so as to fluid-communicate with the space 130. More specifically, the communicating pipe 400 may be connected with the space 130 through the upper filter paper 110. Further, the communicating pipe 400 is also made of a plastic resin material and may be bonded to the upper filter paper 110 by the welding method, and the like to penetrate through the upper filter paper 110. In this case, the lower end of the communicating pipe 400 disposed inside the space 130 of the filter paper 100 is provided with a plurality of plates which radially protrude, are spaced apart from each other along a circumferential direction, and protrude down from the lower end of the communicating pipe 400 and thus the lower end of the communicating pipe 400 does not contact the lower filter paper 120, thereby smoothing the filtering and injection of fuel.

Therefore, the strainer 1000 according to the exemplary embodiment of the present invention is configured to suck the fuel into the space 130 inside the filter paper 100. During the suction of the fuel, the fuel is filtered through the upper filter paper 110 and the lower filter paper 120 and then the filtered fuel flows along the communicating pipe 400.

In this case, the filter paper 100 and the upper rib 210 are partially folded longitudinally, but the upper and lower filter papers 110 of the filter paper 100 are not to contact each other at the folded portion. That is, as illustrated in FIG. 4, in the state in which the filter paper 100 and the upper rib 210 are partially folded up, the protruding parts 300 support the upper filter paper 110 and the lower filter paper 120 of the folded and rounded portion to maintain the distance between the upper filter paper 110 and the lower filter paper 120.

As described above, the strainer according to the exemplary embodiment of the present invention is formed not to contact the upper and lower filter papers at the folded portion even though the strainer is folded. Therefore, it is possible to prevent the deposition of filtered materials and the stoppage of the filter paper at the folded portion. Further, the upper rib 210 is disposed on the upper surface of the upper filter paper 110 which is the outside of the filter paper 100 and thus the protruding parts 300 protrude down from the upper rib 210, such that the upper rib 210 and the filter paper 100 may be easily folded regardless of the distance between the protruding parts 300. The upper rib 210 is fixed with the upper filter paper 110, such that it is possible to prevent the upper filter paper 110 from being folded inwardly (toward the space of the filter paper 100) at the time of the folding, thereby preventing the upper filter paper 110 and the lower filter paper 120 from contacting each other. Further, the upper rib 210 is provided outside the filter paper 100 and therefore a volume of the space 130 inside the filter paper 100 may be increased, thereby reducing a flowing resistance during the filtering of fuel.

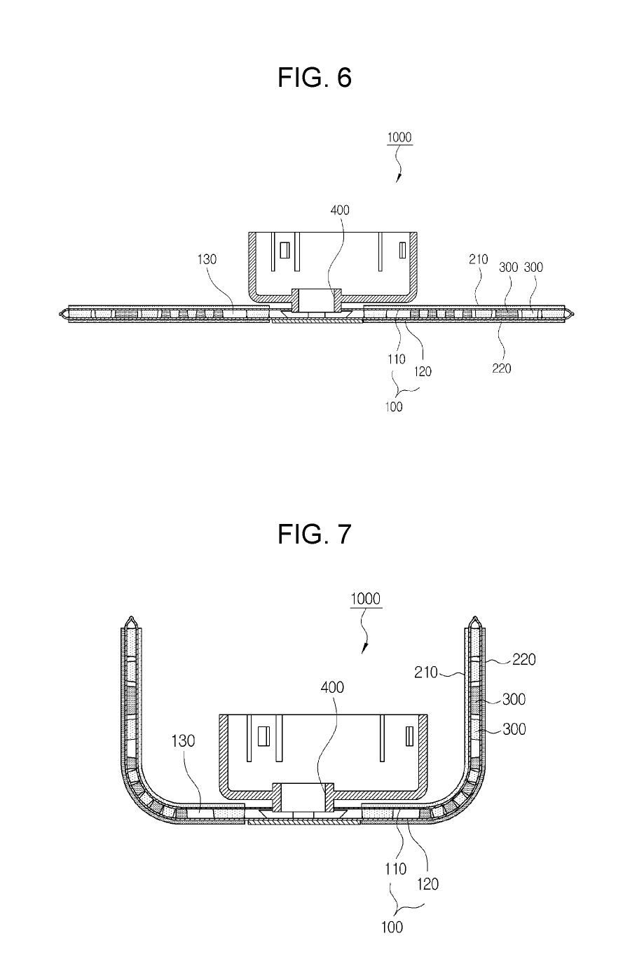

Further, FIGS. 6 to 8 shows a second exemplary embodiment of the present invention. The strainer 1000 according to the second exemplary embodiment of the present invention further includes: a lower rib 220 coupled to the outer bottom portion of the filter paper 100; and the plurality of protruding parts 300 protruding up from the lower rib 220 to be disposed inside the space 130 of the filter paper 100. Similar to the first embodiment, in the second embodiment, the filter paper 100, the upper rib 210, and the lower rib 220 may be partially folded longitudinally and the upper and lower filter papers of the filter paper 100 may be not to contact each other at the folded portion by means of the protruding parts 300 of both the upper rib 210 and the lower rib 220.

As illustrated in FIGS. 6 to 8, in the strainer according to the second exemplary embodiment of the present invention, the lower rib 220 is additionally provided at the lower surface of the lower filter paper 120 and the protruding part 300 protrudes up from the lower rib 220 to be disposed in the space 130 inside of the filter paper 100.

Therefore, even though the strainer is folded, the form of the filter paper 100 is easily maintained by the upper rib 210 and the lower rib 220 which are each provided with the plurality of protruding parts 300 and thus the upper and lower filter papers are not to contact each other at the portion folded by the protruding parts. Therefore, it is possible to prevent the deposition of the filtered materials and the stoppage of the space 130 of the filter paper 100 at the folded portion.

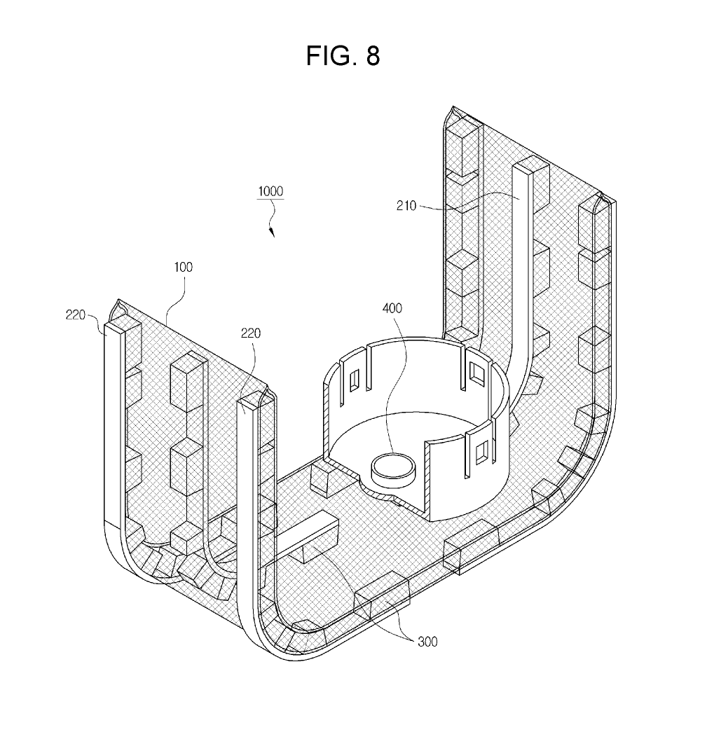

In this case, the upper rib 210 and the lower rib 220 may be in parallel to be spaced apart from each other in the width direction of the filter paper 100 and the upper rib 210 and the lower rib 220 may be alternately disposed, as illustrated in FIG. 8. That is, the upper rib 210 is disposed at a center in the width direction of the upper filter paper 110 and the lower rib 220 is disposed at both sides in the width direction of the lower filter paper 120, such that the upper rib 210 and the lower rib 220 may be formed to be alternately disposed in parallel so as to be spaced apart from each other in the width direction of the filter paper 100.

Therefore, the distance between the upper and lower filter papers at the portion at which the strainer is folded is easily maintained, such that it is possible to prevent the deposition of the filtered materials and the stoppage of the space inside the filter paper at the folded portion.

Further, widths W of the protruding parts 300 may be different from each other and distances D between the protruding parts may be different from each other. Further, the width W of the protruding part 300 and the distance D between the protruding parts 300 may be relatively narrow at the portion at which the filter paper 100 is folded, as shown in FIGS. 7 and 8.

That is, in connection with the plurality of protruding parts 300 protruding down from the upper rib 210, the width W of the protruding part and the distance D between the protruding parts are formed to be narrower at the folded portion than any other portion. Therefore, when the strainer is folded, the lower filter paper 120 is supported by the protruding parts 300 to easily maintain the distance between the upper and lower filter papers. Similarly, in connection with the protruding parts 300 protruding up from the lower rib 220, the width W of the protruding part and the distance D between the protruding parts are formed to be narrower at the portion at which the strainer is folded than any other portion and, thus, when the strainer is folded, the protruding parts 300 are easily support the upper filtering paper 120.

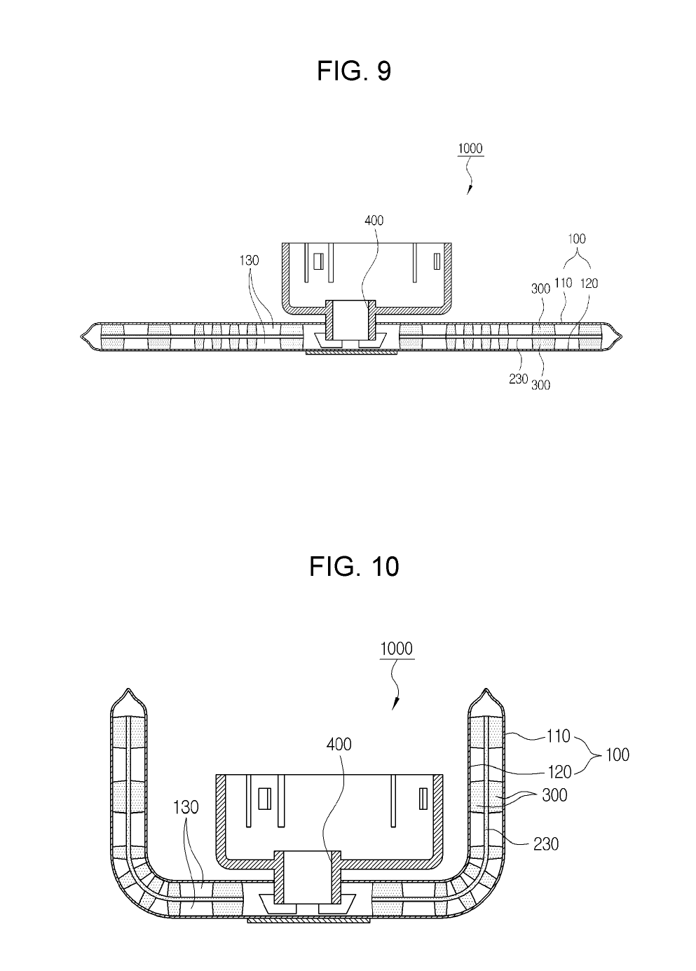

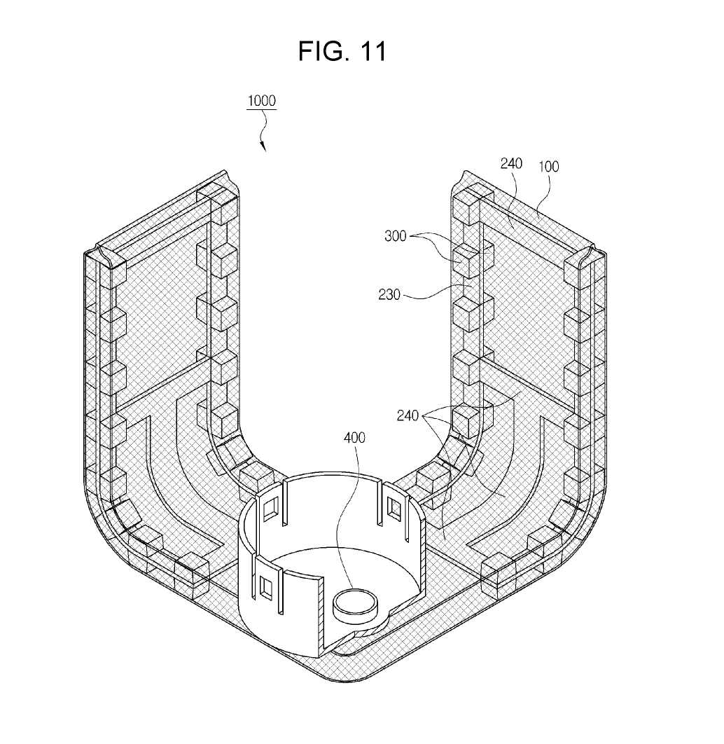

Further, FIGS. 9 to 11 illustrate a third embodiment of the present invention. The strainer 1000 according to the third exemplary embodiment of the present invention includes: the filter paper 100 filtering fuel and having the space 130 formed disposed therein; an inner rib 230 disposed inside the space of the filter paper 100; a plurality of protruding parts 300 protruding up and down from the inner rib 230 to be disposed inside the space 130 of the filter paper 100; and the communicating pipe 400 mounted in the filter paper 100 to fluid-communicate with the space 130 of the filter paper 100. The filter paper 100 and the inner rib 230 are partially folded longitudinally and the upper and lower portions of the filter paper 100 are formed not to contact each other at the folded portion by filter paper 110 the protruding parts 300.

Similar to the first and second embodiment, the filter paper 100 is formed of an upper filter paper 110 and a lower filter paper 120, edges of which are bonded or welded to each other to define the space 130 of the filter paper 100.

As illustrated in FIGS. 9 to 11, the inner rib 230 is disposed inside the space 130 of the filter paper 100, and the upper and lower portions of the inner rib 230 are provided with the plurality of protruding parts 300 in such a manner that the upper filter paper 110 and the lower filter paper 120 are not contacted to each other at the portion where the strainer is folded. In this case, in the state in which the upper and lower portions of the inner rib 230 are integrally provided with the protruding parts 300, the inner rib 230 is inserted into the space 130 of the filter paper 100 and then the edge portions of the upper filter paper 110 and the lower filter paper 120 may be sealed by the welding method, and the like.

Therefore, in the strainer according to the third exemplary embodiment of the present invention, the protruding parts 300 formed on the upper and lower portions of the inner rib 230 support the upper filter paper 110 and the lower filter paper 120, such that the upper filter paper 110 and the lower filter paper 120 may not contact each other to maintain the distance in-between.

Further, as illustrated in FIG. 11, in the strainer according to the third exemplary embodiment of the present invention, the filter paper 100 is formed in an asymmetrical form and thus may also be formed to be partially folded up.

Further, similarly to the first and second embodiments, in the strainer according to the third exemplary embodiment of the present invention, the widths W of the protruding parts may be different from each other and the distances D between the protruding parts may be different from each other. Further, the width W of the protruding part and the distance D between the protruding parts may be relatively narrow at the portion at which the filter paper 100 is folded.

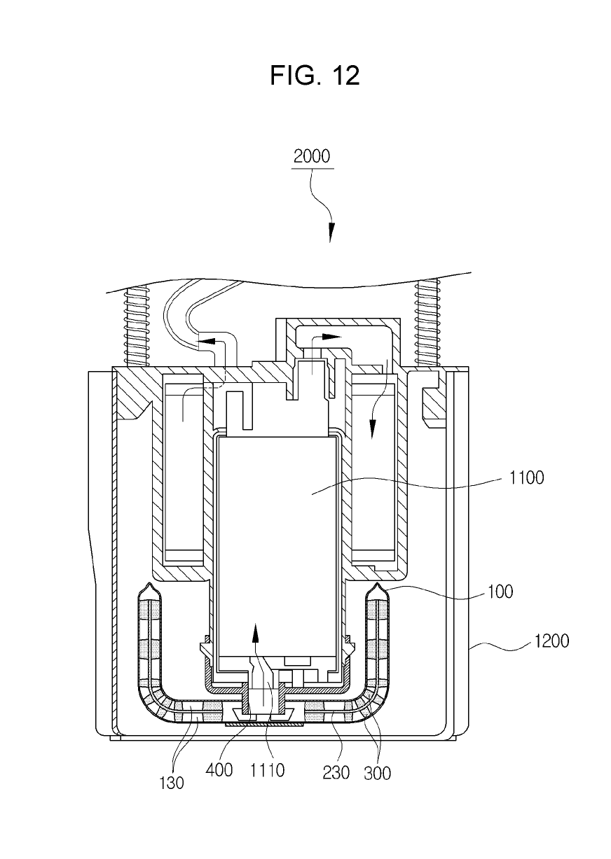

Further, FIG. 12 illustrates a fuel pump module 2000 according to an exemplary embodiment of the present invention. The fuel pump module 2000 is configured to include the strainer 1000, in which the strainer 1000 is disposed inside a reservoir body 1200 in the partially folded state and the communicating pipe 400 of the strainer 1000 is configured to be connected to an inlet 1110 of the fuel pump 1100 which is disposed inside the reservoir body 1200.

That is, as illustrated in FIG. 12, the fuel pump module 2000 according to the exemplary embodiment of the present invention is disposed inside the fuel tank and thus the fuel inside the fuel tank is partially filled inside the reservoir body 1200, and the communicating pipe 400 of the strainer 1000 is connected to the inlet 1110 of the fuel pump 1100 so that the fuel in the reservoir body 1200 may be sucked into the fuel pump 1100 through the strainer 1000. Therefore, the fuel pump module 2000 may be configured so that the filtered fuel is sucked into the fuel pump 1100 through the lower portion of the strainer 1000 and both sides of the strainer 1000 which is vertically folded.

As described above, the fuel pump module 2000 according to the exemplary embodiment of the present invention is configured so that the upper and lower filter papers are formed not to contact each other at the portion at which the strainer is folded, and thus it is possible to prevent the deposition of the filtered materials and the stoppage of the filter paper at the folded portion.

According to the strainer and the fuel pump module having the same in accordance with the present invention, even though the strainer is folded, the upper and lower filter papers are formed not to contact each other at the folded portion, thereby preventing the deposition of the filtered materials and the stoppage of the filter paper at the folded portion.

The present invention is not limited to the above-mentioned exemplary embodiments but may be variously applied, and may be variously modified by those skilled in the art to which the present invention pertains without departing from the gist of the present invention claimed in the claims.

What is claimed are:

1. A strainer, comprising:
a filter paper filtering fuel and having a space part disposed therein;
an inner rib disposed inside the filter paper;
a plurality of protruding parts protruding up and down from the inner rib to be disposed inside the filter paper; and
a communicating pipe combined with the filter paper to communicate with the space part of the filter paper,
wherein the filter paper and the inner rib are partially folded up longitudinally, the folded portion is formed in a rounded form, and the upper and lower portions of the filter paper are formed not to contact each other at the folded portion, and
widths W of the protruding parts are each formed differently and distances D between the protruding parts are each formed differently, and the width W of the protruding part and the distance D between the protruding parts are more narrowly formed at the portion at which the filter paper is folded than at the portion at which the filter paper is not folded.

2. A fuel pump module, comprising:
the strainer of claim 1,
wherein the strainer is disposed inside a reservoir body in a partially folded state and a communicating pipe of the strainer is connected to an inlet of the fuel pump which is disposed inside the reservoir body.
